(19) United States
(12) Patent Application Publication
(10) Pub. No.: US 2019/0095536 A1
(43) Pub. Date: Mar. 28, 2019

(54) METHOD AND DEVICE FOR CONTENT RECOMMENDATION AND COMPUTER READABLE STORAGE MEDIUM

(71) Applicant: BOE TECHNOLOGY GROUP CO., LTD., Beijing (CN)

(72) Inventor: Zijun Liu, Beijing (CN)

(21) Appl. No.: 16/017,231

(22) Filed: Jun. 25, 2018

(30) Foreign Application Priority Data
Sep. 22, 2017 (CN) 201710866025.3

(51) Int. Cl. G06F 17/30; H04L 29/08

(52) U.S. Cl. CPC G06F 17/30867; H04L 67/18; H04L 67/26; G06F 17/3087

(57) ABSTRACT

The present disclosure discloses a method and a device for content recommendation and a computer readable storage medium. The method for content recommendation includes: obtaining content information associated with a user; determining address information corresponding to the content information according to the content information; and recommending the content information and the address information, in response to determining that the user is located close to an address indicated by the address information based on current location information of the user and the address information.

### CROSS-REFERENCE TO RELATED APPLICATION

This application claims priority to the Chinese Patent Application No. 201710866025.3, entitled “METHOD, DEVICE, AND APPARATUS FOR CONTENT RECOMMENDATION AND COMPUTER READABLE STORAGE MEDIUM” and filed on Sep. 22, 2017, which is incorporated herein by reference in its entirety.

### BACKGROUND

The present disclosure relates to the field of computer technology, and more particularly to a method and a device for content recommendation, and to a computer readable storage medium.

In databases of museums of art, information about which museum or art gallery a painting is collected in is recorded. However, it is only limited to providing users with collection information of the painting, and the information, such as geography information corresponding to the museum, art gallery or exhibition hall, and other collection information, is not sufficiently used. A user who is interested in art work may miss an opportunity to appreciate the art work on site when he/she is visiting a city, because he/she does not know the paintings he/she likes are being exhibited in a local exhibition hall.

### SUMMARY

In order to at least partially solve or alleviate the above-mentioned defects or deficiencies, the present disclosure provides a content recommendation method and a content recommendation device.

In a first aspect, the present disclosure provides a content recommendation method. The content recommendation method includes: obtaining content information associated with a user; determining address information corresponding to the content information according to the content information; and recommending the content information and the address information, in response to determining that the user is located close to an address indicated by the address information based on current location information of the user and the address information.

In a second aspect, the present disclosure provides a content recommendation device. The content recommendation device includes: a processor; a memory storing instructions which, when executed by the processor, cause the processor to: obtain content information associated with a user; determine address information corresponding to the content information according to the content information; and recommend the content information and the address information, in response to determining that the user is located close to an address indicated by the address information based on current location information of the user and the address information.

In a third aspect, the present disclosure provides a computer readable storage medium storing computer program, which, when executed by a processor, causes the processor to implement the content recommendation methods provided by various embodiments.

### BRIEF DESCRIPTION OF THE DRAWINGS

Other features, objects, and advantages of the present disclosure will become more apparent from reading following detailed description of non-limiting embodiments with reference to following drawings.

FIG. 1 shows an exemplary system architecture to which the embodiments of the present disclosure may be applied.

FIG. 2 shows an exemplary flowchart of a content recommendation method according to an embodiment of the present disclosure.

FIG. 3 shows an exemplary flowchart of a determining method for a recommendation in step S13 as shown in FIG. 2.

FIG. 4 shows an exemplary schematic diagram of a content recommendation device according to an embodiment of the present disclosure.

FIG. 5 shows a schematic structure diagram of a content recommendation device according to another embodiment of the present disclosure.

### DETAILED DESCRIPTION

The present disclosure will be further described in detail below with reference to the accompanying drawings and the embodiments. It may be understood that the specific embodiments described herein are merely used to explain the related invention but not to limit the invention. It should also be noted that for ease of description, only those parts related to the present disclosure are shown in the drawings.

It should be noted that the embodiments in the present disclosure and features in the embodiments may be combined with each other without conflict. The present disclosure will be described in detail below with reference to the drawings and in combination with the embodiments.

According to the technical solutions provided by the embodiments of the present disclosure, pushing various recommendation information according to current location information of a user and address information corresponding to content information associated with the user may at least partially alleviate a problem in the related art that the recommended content is pale and monotonous, thereby preventing the user from missing the entity of interest. Further, according to some embodiments of the present disclosure, by pushing navigation information based on the address information corresponding to the content information, the navigation may be more humanized.

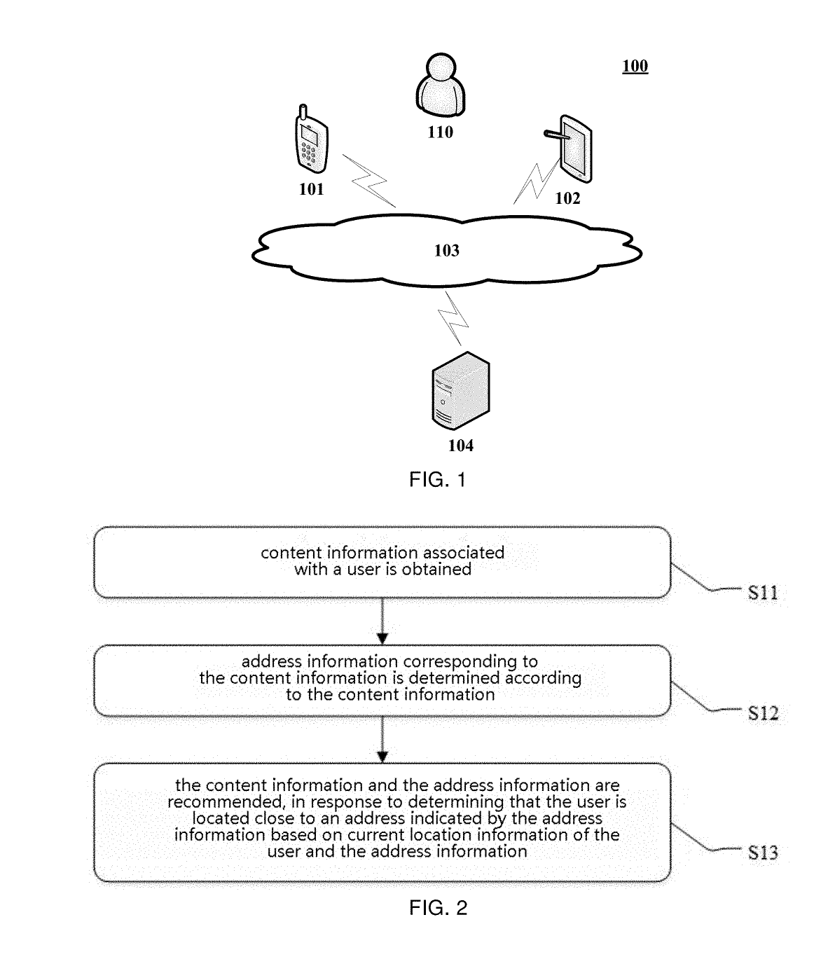

FIG. 1 shows an exemplary system architecture 100 to which the embodiments of the present disclosure may be applied.

As shown in FIG. 1, the system architecture 100 may include terminal devices 101, 102, a network 103, and a server 104. The network 103 serves to provide a medium of a communication link between the terminal devices 101, 102 and the server 104. The network 103 may include various connection types, such as wired, wireless communication links or fiber optic cables and the like.

The user 110 may use the terminal devices 101, 102 to interact with the server 104 over the network 103 to receive or transmit messages or the like.

The terminal devices 101, 102 may be various electronic devices, including, but not limited to, personal computers, smart phones, smart watches, tablet computers, personal digital assistants, and the like.

The server 104 may be a server that provides various services. The server may process (such as store, analyze) the received data, and feed a processing result to the terminal device.

It should be noted that the content recommendation method provided in the embodiment of the present disclosure may be executed by the server 104. In some embodiments, the content recommendation method may make a recommendation in the server 104, and the terminal device 101, 102 may be installed with a software application, such as an APP, which receives the user's interactive operation.

It should be understood that numbers of the terminal devices, network and servers in FIG. 1 are merely illustrative. Depending on actual implementations as required, there may be any numbers of the terminal devices, network and servers.

With reference to FIG. 2, FIG. 2 shows an exemplary flowchart of a content recommendation method according to an embodiment of the present disclosure. The method as shown in FIG. 2 may be performed on the server 104 of FIG. 1.

At step S11, content information associated with a user is obtained.

At step S12, address information corresponding to the content information is determined according to the content information.

At step S13, the content information and the address information are recommended, in response to determining that the user is located close to an address indicated by the address information based on current location information of the user and the address information. In addition, in some other embodiments, when it is determined that the user is not located close to the address indicated by the address information based on the current location information of the user and the address information, no information may be recommended to the user.

In step S11, various content information associated with the user may be obtained. The content information may include at least one of: art work information, restaurant information, museum information, library information, scenic spot information etc. The above information may be obtained from concerned information, collection information, information of interest, subscription information, or information that is previously browsed, which are set or selected by the user.

In step S12, geographic location information corresponding to the content information is determined. For example, when the information the user is interested in is a painting, information of an art gallery where the painting is located is determined, and geographic location information of the art gallery is determined as the address information. In some embodiments, the determination may be implemented by querying local or online related databases with a keyword, such as a name of the painting (or more generally, an identifier thereof).

In step S13, the current location information of the user is obtained, and it is determined whether the user is close to the address according to the address information determined in step S12 and the current location information of the user. If yes, the content information and the address information may be recommended to the user, prompting the user that he/she is closer to the art gallery and may consider taking a visit, so that the user will not miss the opportunity to visit the art work he/she is interested in. The current location information may be obtained by receiving GPS location information of the user's user terminal.

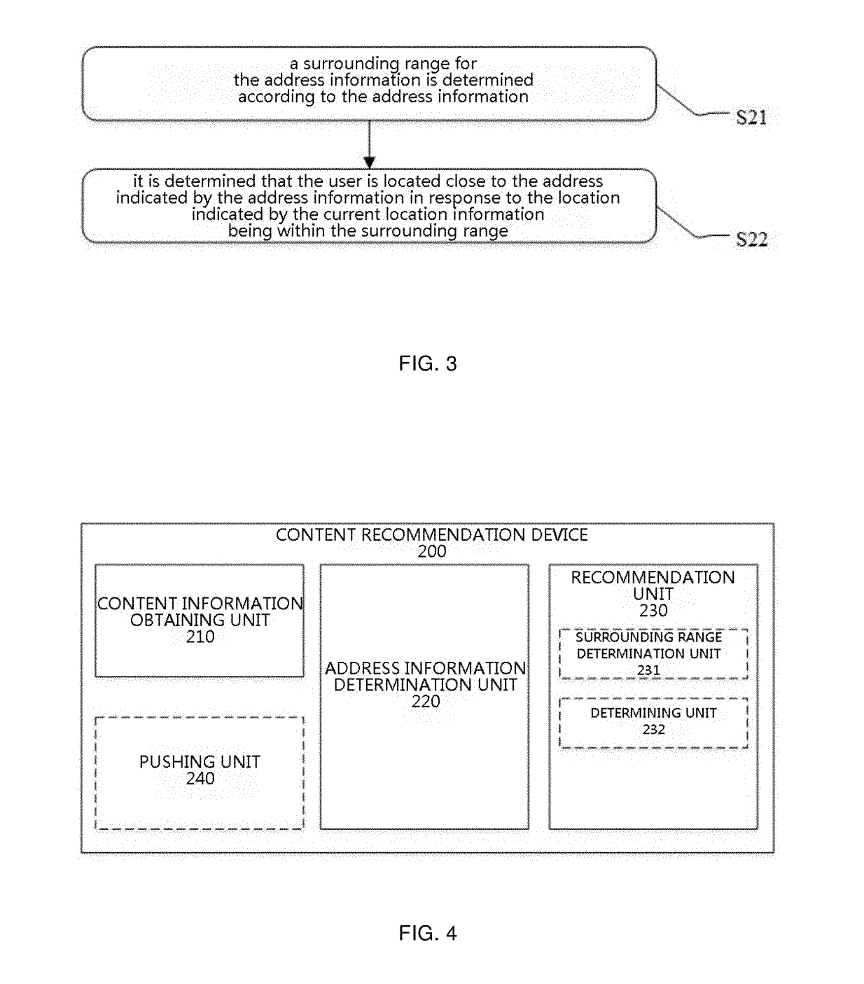

Next, FIG. 3 shows an exemplary flowchart of a determining method for the recommendation in step S13 as shown in FIG. 2. Step S13 includes:

Step S21 of determining a surrounding range for the address information according to the address information; and

Step S22 of determining that the user is located close to the address indicated by the address information in response to the location indicated by the current location information being within the surrounding range. In some other embodiments, when the location indicated by the current location information is not within the surrounding range, it may be determined that the user is not located close to the address indicated by the address information.

In step S21, the surrounding range for the city in which the art gallery is located or the surrounding range which centers on the art gallery and has a predetermined distance from the art gallery is determined based on the address information determined in step S12. In specific applications, the surrounding range may be an administrative area, and whether the administrative area is provincial, county or in any other area range may be adjusted according to particular requirements. When the art gallery is located at a junction of cities, there may be a situation where the art gallery belongs to a plurality of administrative areas. Alternatively, a surrounding area, such as a circular surrounding area, a square surrounding area, etc., which centers on the address information and has a predetermined distance from the address information is calculated.

In step S22, it is determined whether the current position information obtained in step S13 is within the surrounding range determined in step S22.

Alternatively, if the user is within the surrounding range, the recommendation information associated with the content information or the surrounding range is pushed, e.g., other art work that are collected in the art gallery and booths of the art work in the art gallery, or other places of historic interest close to the art gallery.

In some embodiments, navigation information associated with the address information is pushed, so that the user is facilitated to quickly reach his/her destination. Specifically, the art gallery, where the painting that the user is interested in, is located in Paris. When the system receives information that the user's location moves to Paris, it sends to the user location information of the art gallery where the painting of interest is located, and prompts the user with corresponding navigation services that the system may provide.

FIG. 4 shows an exemplary schematic diagram of a content recommendation device 200 according to an embodiment of the present disclosure. As shown in FIG. 4, the device 200 may include: a content information obtaining unit 210, configured to obtain content information associated with a user; an address information determination unit 220, configured to determine address information corresponding to the content information according to the content information; and a recommendation unit 230, configured to recommend the content information and the address information, in response to determining that the user is located close to an address indicated by the address information based on current location information of the user and the address information.

The content information includes at least one of: art work information, restaurant information, museum information, library information, scenic spot information etc.

The content recommendation device 200 as shown in FIG. 4 may perform the content recommendation method as shown in FIG. 2 accordingly.

Alternatively, the recommendation unit 230 may include: a surrounding range determination unit 231, configured to determine a surrounding range for the address information according to the address information; and a determining unit 232 is configured to determine that the user is located close to the address indicated by the address information, in response to the position indicated by the current position information is within the surrounding range.

The recommendation unit 230 shown in FIG. 4 may perform the determining method for the recommendation in step S13.

In some embodiments, the content recommendation device 200 may further include a pushing unit 240 configured to push recommendation information associated with at least one of the content information and the surrounding range.

Alternatively, the pushing unit 240 is further configured to push navigation information associated with the address information.

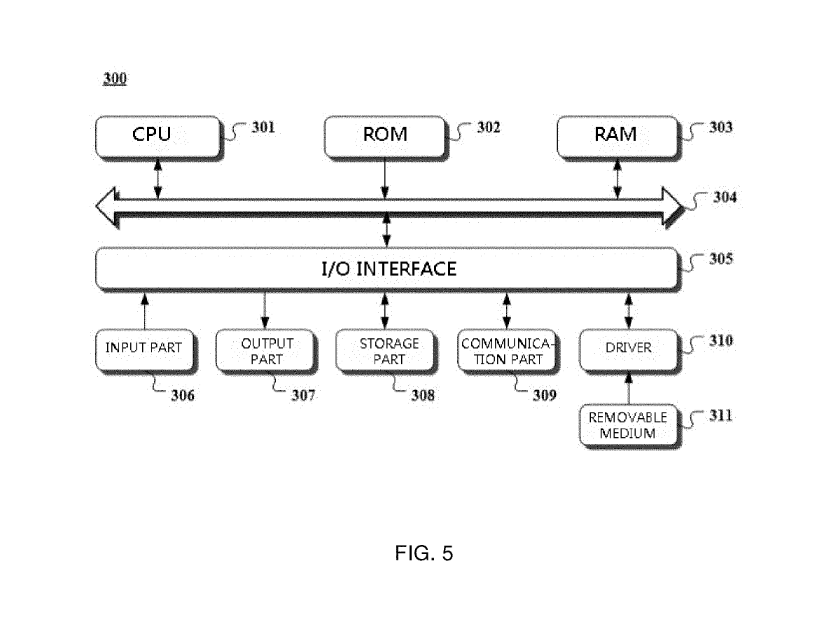

FIG. 5 shows a schematic structure diagram of a content recommendation device 300 according to another embodiment of the present disclosure. The content recommendation device 300 may include a processor and a memory. The memory may store instructions which, when executed by the processor, cause the processor to obtain content information associated with a user, to determine address information corresponding to the content information according to the content information; and to recommend the content information and the address information, in response to determining that the user is located close to an address indicated by the address information based on current location information of the user and the address information. Further, the instructions, when executed by the processor, may further cause the processor to perform operations as described above with reference to FIGS. 2 and 3.

In some embodiments, the processor of the content recommendation device 300 may include one or more central processing units (CPU) 301, which may perform various actions and processes according to programs stored in the memory. In some embodiments, the memory of the content recommendation device 300 may include a read only memory (ROM) 302, a random access memory (RAM) 303, a storage part 308, and/or a removable medium 311. In the RAM 303, various programs and/or data necessary for operations of the content recommendation device 300 may be stored. The CPU 301, the ROM 302, and the RAM 303 may be connected to each other via a bus 304. An input/output (I/O) interface 305 may also be connected to the bus 304.

The following components may be connected to the I/O interface 305: an input part 306 including a keyboard, a mouse, and the like; an output part 307 including a cathode ray tube (CRT), a liquid crystal display (LCD), etc., and a speaker, etc.; and the storage part 308 including a hard disk, etc.; and a communication part 309 including a network interface card, such as a LAN card, a modem, and the like. The communication part 309 performs communication processing via a network, such as the Internet. The driver 310 is also connected to the I/O interface 305 as required. A removable medium 311, such as a magnetic disk, an optical disk, a magneto-optical disk, a semiconductor memory, etc., is mounted on the driver 310 as required, so that a computer program read therefrom may be installed into the storage part 308 as required.

In particular, according to the embodiments of the present disclosure, the processes described above with reference to FIG. 2 and/or FIG. 3 may be implemented as computer software programs. For example, the embodiments of the present disclosure include a computer program product including computer programs tangibly embodied on a machine readable medium, and the computer program contains program codes for performing the content recommendation method. In such an embodiment, the computer program may be downloaded from the network through the communication part 309 and installed, and/or installed from the removable medium 311. Specifically, the concerned user-associated content information, the address information, and the recommendation information associated with the content information and the surrounding range, and the navigation information associated with the address information may be stored in the ROM 302 or the removable medium 311 as a database for being invoked by the program.

The flowcharts and block diagrams in the accompany drawings illustrate the architectures, functions, and operations of possible implementations of the systems, methods, and computer program products according to various embodiments of the present disclosure. In this regard, each block in the flowcharts or block diagrams may represent a module, a program segment, or a portion of codes which may contain one or more executable instructions for implementing specified logical functions. It should also be noted that in some implementations as an alternative, the functions noted in the blocks may also occur in different orders from those noted in the drawings. For example, two consecutively represented blocks may actually be executed substantially in parallel, and may sometimes be executed in a reverse order, depending on the functions involved. It is also noted that each block in the block diagrams and/or flowcharts, and combinations of the blocks in the block diagrams and/or flowcharts may be implemented by special purpose hardware-based systems that perform the specified functions or operations, or can be implemented by combinations of dedicated hardware and computer instructions.

As yet another aspect, the present disclosure further provides a computer readable storage medium, which may be a computer readable storage medium included in the device in the above embodiment; or may also exist alone, but may not be incorporated in the computer readable storage medium in the device. A computer readable storage medium stores one or more programs that are used by one or more processors to perform the content recommendation methods as described in the present disclosure.

The units or modules described in the embodiments of the present disclosure may be implemented as software or hardware. The described units or modules may also be provided in the processor. For example, each of the units may be a software program installed in a computer or a mobile smart device, or may be separately configured hardware apparatuses. Among them, the names of these units or modules do not constitute limitations to the units or the modules per se in some cases.

The above description is only a part of the embodiments of the present disclosure and description of the applied technical principles. It should be understood by the skilled in the art that the scope of the present disclosure is not limited to the technical solutions obtained by specific combinations of the above technical features, but it should also cover other technical solutions obtained by any combinations of the above technical features and equivalents thereof without departing from the concept, e.g., the technical solutions obtained by mutual replacement of the features and the technical features disclosed in the present disclosure (but not limited to) having similar functions.

I/We claim:

1. A content recommendation method, comprising:
obtaining content information associated with a user;
determining address information corresponding to the content information according to the content information; and
recommending the content information and the address information, in response to determining that the user is located close to an address indicated by the address information based on current location information of the user and the address information.

2. The method according to claim 1, wherein the determining that the user is located close to the address indicated by the address information based on the current location information of the user and the address information comprises:
determining a surrounding range for the address information according to the address information; and
determining that the user is located close to the address indicated by the address information in response to the location indicated by the current location information being within the surrounding range.

3. The method according to claim 2, further comprising:
pushing recommendation information associated with at least one of the content information and the surrounding range.

4. The method according to claim 3, further comprising:
pushing navigation information associated with the address information.

5. The method according to claim 1, wherein the content information comprises at least one of: art work information, restaurant information, museum information, library information, scenic spot information.

6. The method according claim 1, wherein the obtaining content information associated with a user comprises:
obtaining the content information from at least one of concerned information, collection information, information of interest, subscription information, or information that is previously browsed.

7. A content recommendation device, comprising:
a processor;
a memory storing instructions which, when executed by the processor, cause the processor to:
obtain content information associated with a user;
determine address information corresponding to the content information according to the content information; and
recommend the content information and the address information, in response to determining that the user is located close to an address indicated by the address information based on current location information of the user and the address information.

8. The content recommendation device according to claim 7, wherein the instructions, when executed by the processor, further cause the processor to:
determine a surrounding range for the address information according to the address information; and
determine that the user is located close to the address indicated by the address information in response to the location indicated by the current location information being within the surrounding range.

9. The content recommendation device according to claim 8, wherein the instructions, when executed by the processor, further cause the processor to:
push recommendation information associated with at least one of the content information and the surrounding range.

10. The content recommendation device according to claim 9, wherein the instructions, when executed by the processor, further cause the processor to:
push navigation information associated with the address information.

11. The content recommendation device according to claim 7, wherein the content information comprises at least one of: art work information, restaurant information, museum information, library information, scenic spot information.

12. The content recommendation device according to claim 7, wherein the instructions, when executed by the processor, further cause the processor to:
obtain the content information from at least one of concerned information, collection information, information of interest, subscription information, or information that is previously browsed.

13. A computer readable storage medium storing computer program, which, when executed by a processor, causes the processor to implement the content recommendation method according to claim 1.
